(19) United States
(12) Patent Application Publication
(10) Pub. No.: US 2009/0060496 A1
(43) Pub. Date: Mar. 5, 2009

(54) Method and system for enabling diagnosing of faults in a passive optical network

(76) Inventors: David H. Liu, Herndon, VA (US); Sreeram Venkataraman, Ashburn, VA (US); Peter L. Randall, Centerville, VA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/897,958

(22) Filed: Aug. 31, 2007

(51) Int. Cl. H04B 10/08

(52) U.S. Cl. 398/17

(57) ABSTRACT

In a passive optical network (PON), multiple optical network terminals (ONTS) transmit data to an optical line terminal (OLT) using a common optical wavelength and fiber optical media. Various components of the PON, including the OLT and ONT(s), can malfunction. Centralized techniques for maintaining or diagnosing fault conditions may be ineffective in large networks or in relatively small networks because of vast amounts of information and limited storage capacity for the information. Thus, fault conditions may occur and not be diagnosed due to lost or overwritten information. Therefore, a distributed approach based on information related to ranging of ONTs within the PON is employed in an example embodiment of the invention. This distributed approach can improve monitoring and diagnosis of fault conditions that may lead to instability of the PON.

### BACKGROUND OF THE INVENTION

In a passive optical network (PON), multiple optical network terminals (ONTS) transmit data to an optical line terminal (OLT) using a common optical wavelength and fiber optic media. Various components of the PON, including the OLT and ONT(s), can malfunction. It has always been very difficult to monitor stability of the ONT and diagnose a source of instability in part because of inherent characteristics of signaling paths within a PON.

In an event of an alarm condition on the ONT, the ONT may transmit a message autonomously to the OLT, which, in turn, may transmit a message to report the alarm condition to a management system. However, when dealing with a large number of ONTs for a long duration of time, it becomes less feasible to rely on the management system to handle a large number of alarm conditions and diagnose causes of the alarm conditions.

Some information generated or learned by the ONTs cannot be retrieved from ONTs in certain circumstances. For example, existing methods rely on a management system, such as an Element Management System (EMS), capable of logging alarms that are received from ONTs. However, whenever there is a re-range condition, a Lost of Physical Link—Loss of Signal (LOPL—LOS) alarm is generated by the ONTs and is cleared at the ONTs as soon as the condition clears. Also, the EMS has a limit to the number of alarms it can store, and alarms beyond the limit are lost or overwrite previously stored alarms. Thus, diagnosing faults in a passive optical network is challenging.

### SUMMARY OF THE INVENTION

A method and system of enabling diagnosing of faults in a passive optical network (PON) according to an example embodiment of the invention may include identifying a correspondence between the ranging information representative of a length of time since ranging a given optical network terminal (ONT) and state information of the given ONT, or another PON device associated with operation of the given ONT. The example embodiment may further include reporting the correspondence to enable diagnosing faults in the PON.

A further example embodiment of the invention provides a network management service for a passive optical network (PON). The network management service may include determining stability of at least a first node in the passive optical network as a function of a length of time the first node has remained synchronized with at least one second node in the PON. The network management service may further include identifying a correspondence between the stability of the first node and state information of the first node, another PON device, or the at least one second node associated with operation of the first node. A fee is collected for the service.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a high level network diagram of a communications network with a service to facilitate communications and diagnosis between service provider network equipment and end-user network equipment;

FIG. 2 is a laboratory test setup diagram with a laboratory database connected to the serial ports of several Optical Network Terminal (ONT) devices;

FIG. 3 is a communications diagram demonstrating interaction between an Optical Line Terminal (OLT) and an Optical Network Terminal (ONT);

FIG. 4 is a communications diagram demonstrating interaction between several Optical Line Terminal (OLT) devices and an Element Management System (EMS);

FIG. 5 is a communications diagram demonstrating the interaction between the EMS devices, a Network Management System (NMS), and a Service Provider;

FIG. 6 is a flow diagram illustrating a process of retrieving ranging event data from an ONT;

FIG. 7 is a sample report of ranging event data obtained from the Optical Network Terminal (ONT) devices;

FIG. 8 is a timeline diagram demonstrating ranging event data;

FIG. 9 is a sample report containing the ranging event data of each Optical Network Terminal (ONT) device and the information of the ONT, Optical Line Terminal (OLT), and other PON devices associated with the ONT;

FIG. 10A is a sample network stability report characterizing a level of attention used to service an unstable PON device;

FIG. 10B is a plot of a network metric representing average instability of the PON network, with the plot associating instability of the PON with an event;

FIGS. 11A-B are flow diagrams illustrating example embodimenst of the present invention;

FIG. 12 is a flow diagram illustrating the process of correlating ranging event data with state information of devices in the PON;

FIG. 13 is a flow diagram illustrating an analysis and categorization of the correlated data of FIG. 12;

FIG. 14 is a network diagram illustrating typical parties associated with network stability maintenance of a PON;

FIG. 15 is a network diagram illustrating interaction of a manufacturer, content provider, and advertiser in a context of a Wide Area Network (WAN), PON, and network stability server;

FIG. 16 is a network diagram illustrating the interaction of a manufacturer, service provider, and third-party auditing service provider in the context of the WAN and PON; and

FIG. 17 is a flow diagram illustrating the network management service provided within the networks of FIG. 16 or 17.

### DETAILED DESCRIPTION OF THE INVENTION

A description of example embodiments of the invention follows.

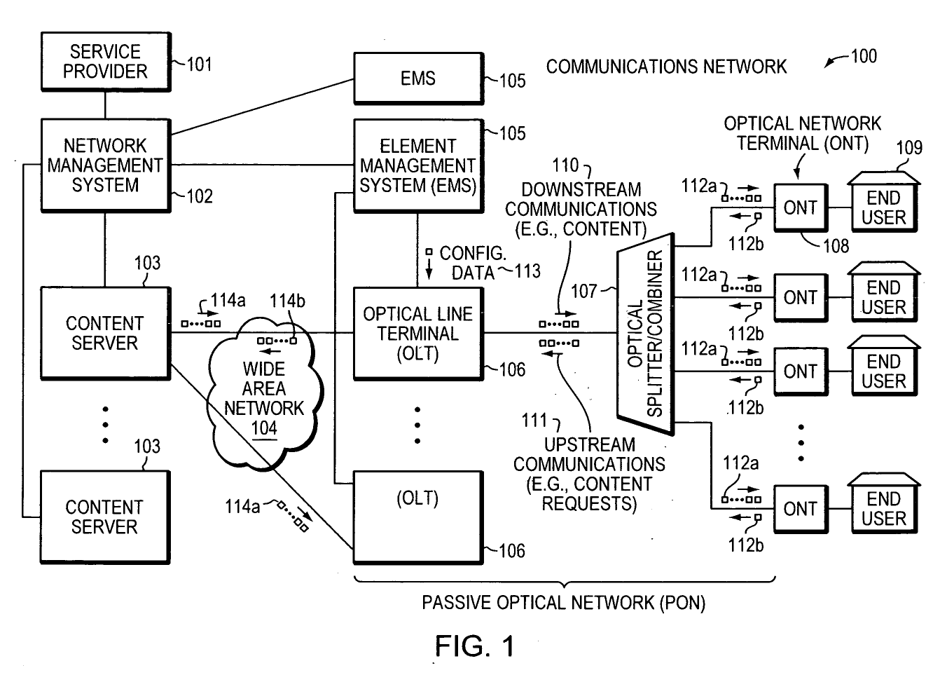

An example embodiment of the invention enables diagnosing of faults in a passive optical network (PON). Diagnosis can be difficult due to alarm message storage constraints in large networks and alarm and state information clearing or changing at nodes generating alarm messages after a change in alarm or other state by the nodes generating the alarm messages or by associated nodes. Centralized techniques for maintaining or diagnosing the alarm conditions are thus limited or ineffective. Therefore, a distributed approach based on information related to ranging of optical network terminals (ONTs) within the PON is employed in an example embodiment of the invention. The information related to ranging used by the example embodiment serves to overcome problems previously encountered in diagnosing faults in a PON, as described above. Before presenting details of example embodiments of the invention a description of a PON is presented in reference to FIG. 1.

FIG. 1 is a network diagram of a passive optical network (PON) 100 illustrating aspects of an example embodiment of the invention. The PON 100 includes a service provider 101, a network management system 102, at least one content server 103, a wide area network (WAN) 104, at least one element management system (EMS) 105, at least one optical line terminal (OLT) 106, an optical splitter/combiner (OSC) 107, at least one optical network terminal (ONT) 108, and at least one end user 109. In other network embodiments, optical network units (ONUs) (not shown) may be in optical communication with multiple ONT(s) 108 or directly in electrical communication with end user equipment, such as routers, telephones, home security systems, and so forth (not shown). As presented herein, data communications 114a-114n may be transmitted to the OLT 106 via the WAN 104. The data communications are provided by the content server 103. “Data” as used herein refers to voice, video, analog, or digital data.

The element management system 105 may provide configuration data 113 to the OLT 106. The configuration data 113 facilitates communication of downstream data (e.g., content) 110 between the OLT 106 and ONTs 108. Communications may be performed using standard communications protocols known in the art. For example, downstream data 110 may be broadcast with identification (ID) data to identify intended recipients for transmitting the downstream data 110 from the OLT 106 to the ONT(s) 108. Time division multiple access (TDMA) may be used for transmitting the upstream data 111 from individual ONT(s) 108 back to the OLT 106. Note that the downstream data 110 is power divided by the OSC 107 into downstream data 112a matching the downstream data 110 “above” the OSC 107, but with power reduced proportionally to the number of paths onto which the OSC 107 divides the downstream data 120. It should be understood that, in an optical network environment, the terms “downstream data” 110, 112a and “upstream data” 111, 112b refer to optical traffic signals that typically travel via optical communications path(s), such as optical fiber(s).

The PON 100 may be deployed for fiber-to-the-premise (FTTP), fiber-to-the-curb (FTTC), fiber-to-the-node (FTTN), and other fiber-to-the-X (FTTX) applications. The optical fiber in the PON 100 may operate at various bandwidths, such as 155 megabits per second (Mbps), 622 Mbps, 1.244 gigabits per second (Gbps), 2.488 Gbps, or other bandwidth implementations. The PON 100 may incorporate asynchronous transfer mode (ATM) communications, broadband services such as Ethernet access and video distribution, Ethernet point-to-multipoint topologies, and native communications of data in time division multiplexing (TDM) formats or other communications formats suitable for a PON 100. ONT(s) 108 may provide and receive communications to and from the PON 100 and may be connected to standard telephones (e.g., PSTN02 and cellular), Internet Protocol (IP) telephones for Voice-over-IP (VoIP) services, Ethernet units, video devices, computer terminals, digital subscriber lines, wireless access, as well as any other conventional or future customer premise equipment.

The OLT 106 generates or passes downstream communications 110 to the OSC 107. After flowing through the OSC 107, the downstream communications 110 are broadcast as power reduced downstream communications 112a to the ONT(s) 108, where each ONT 108 reads data within received downstream communications 112a intended for that particular ONT 108. The downstream communications 110 may also be broadcast to, for example, another OSC (not shown), where the downstream communications 110 are again split and broadcast to additional ONT(s) 108 and/or ONUs (not shown).

Data communications 112a may be transmitted to an ONT 108 in the form of voice, data, video, and/or telemetry over fiber connection. The ONT(s) 108 transmit upstream communication signals 112b back to the OSC 107 via an optical link, such as a fiber connection. The OSC 107, in turn, combines upstream signals 112b from all connected ONTs 108 and transmits a combined signal 111 back to the OLT 106, which employs, for example, a time division multiplex (TDM) protocol to determine from which ONT 108 portions of the combined signal 111 are received. The OLT 106 may further transmit the communications signals 114b to the content server 103 or NMS 102 via the WAN 104.

Communications between the OLT 106 and the ONT(s) 108 occur using a downstream wavelength, such as 1490 nanometers (nm), and an upstream wavelength, such as 1310 nm. The downstream communications 110 broadcast from the OLT 106 to the ONT(s) 108 may be provided at 2.488 Gbps, which is shared across all ONT(s). The upstream communications transmitted 112b from the ONT(s) 108 to the OLT 106 may be provided at 1.244 Gbps, which is shared among all ONT(s) 108 connected to the OSC 107. Other communications data rates known in the art may also be employed.

To ensure upstream communications do not “collide,” a process known as ranging is performed. Results of ranging the ONTs 108 by the OLT 106 include upstream timing offsets, which are provided to the ONTs 108 for use in knowing how long to wait after receipt of a downstream start-of-frame signal (not shown). For example, following receipt of a downstream communications signal 112a, an ONT waits for its prescribed upstream timing offset before transmitting an upstream communications signal 112b to the OLT 106. Ranging may occur following a power outage, reset, software upgrade, and so forth.

In an example embodiment of the invention, a method, or corresponding system of enabling diagnosing of faults in a passive optical network (PON) includes monitoring ranging information representative of a length of time since ranging an optical network terminal. The embodiment may include identifying a correspondence between the ranging information and state information of the ONT or another PON device associated with operation of the ONT. The correspondence may be reported to enable diagnosing faults in the PON.

The example embodiment may include monitoring a counter indicating a number of times over a length of time an encryption key, used to support encrypted communications between the ONT and an optical line terminal (OLT) in communication with the ONT, changed. The encryption key may be a churning key that changes over time, and the churning key and the number of times the churning key changed may be divided by a metric to determine a length of time since the ONT was most recently ranged.

The example embodiment may also include storing the ranging information. The embodiment may include storing the ranging information in at least one of the following locations: the ONT, an OLT in communication with the ONT, or a management element in communication with the OLT or ONT.

The example embodiment may include diagnosing the faults as a function of the correspondence between the ranging information and the state information. The information may be the state information of at least the ONT, a Battery Backup Unit (BBU) coupled to the ONT, another ONT in the PON, an OLT in communication with the ONT, or a combination of the OLT and ONT.

The example embodiment may also include monitoring the ranging information, identifying the correspondence, and reporting the correspondence in an environment selected from a group consisting of a laboratory environment and a field operations environment.

During the identification of a correspondence between the ranging information and state information, another embodiment may include storing the ranging information and state information in a database and associating a start time of the ranging with a state in the state information. The embodiment may further include converting the ranging information, state information, and the correspondence into a human-readable format.

The example embodiment may also include reporting the correspondence at least locally at the ONT, remotely at an optical line terminal (OLT) in communication with the ONT, or remotely at a management element. Reporting of the correspondence may also include storing the correspondence in a file server in communication with the ONT or an OLT in communication with the ONT.

The example embodiment may also include monitoring the ranging information in traffic on a Physical Layer Operations, Administration, and Maintenance (PLOAM) channel, an Operations Management and Control Interface (OMCI) channel, or an in-band traffic channel.

During the reporting of the correspondence process, the example embodiment may include analyzing the correspondence and categorizing the state information of the PON or ONT as a function of the correspondence. The categorization of the state of the PON or ONT may include assigning a priority level for maintenance.

A network management service for a passive optical network (PON) may also be provided. The network management service may include determining stability of at least a first node in the passive optical network as a function of a length of time the first node has remained synchronized with at least one second node in the PON. The network management service may further include identifying a correspondence between the stability of the first node and state information of the first node, another PON device, or at least the one second node associated with operation of the first node. A fee may be collected for the service.

The network management service may further include correcting a network fault and reporting information about the network fault to at least a service provider, manufacturer, network stability server, content provider, advertiser, or third-party auditing service provider.

The fee for the service may be collected on a subscription basis ranging from a one time, weekly, monthly, or annual subscription basis, invoicing the party for the fee, or collecting the fee on a prepayment basis.

The network management service, in determining the stability of the PON, may further include counting a number of times over a length of time an encryption key, used to support encrypted communications between the first node and at least one second node, changed to determine a length of time the first node has remained synchronized with at least the second node in the PON. The encryption key may be a churning key, and a further method of determining stability of the PON may include dividing the number of times the churning key changed since a most recent ranging by a metric to determine the length of time since the ONT was most recently ranged.

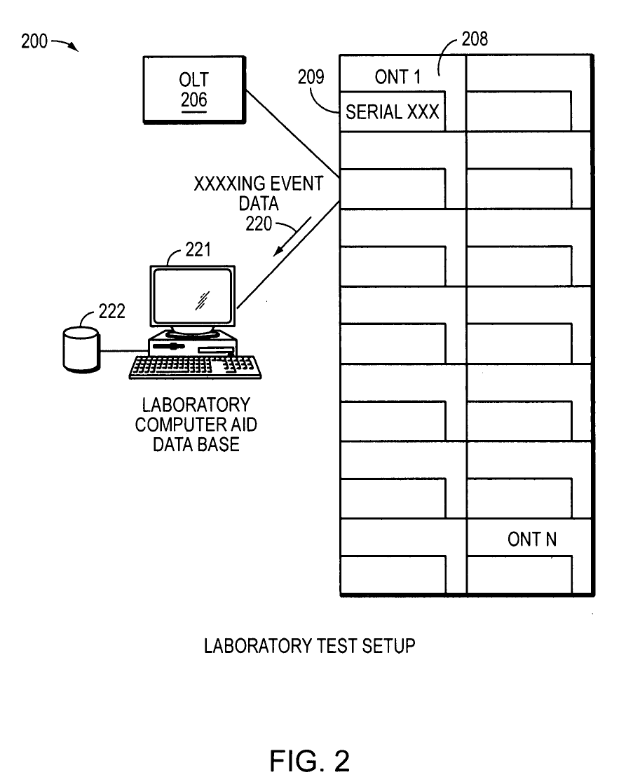

FIG. 2 is a diagram of a laboratory test setup 200, which may be an environment in which an embodiment of the invention is employed. The setup 200 may include a laboratory computer 221 connected to a database 222. The computer 221 is connected to serial ports 209 of several Optical Network Terminal (ONT) 208-1 . . . N. An Optical Line Terminal (OLT) 206 is connected to the ONTs 208-1 . . . N. Communications between the OLT 206 and ONTs 208-1 . . . N may be conducted in a manner similar to that as described in FIG. 1. The laboratory database 221 may be connected to the serial port 209 of the ONTs 208-1 . . . N and collects ranging event data 220 from the ONTs 208-1. N. The laboratory database 221 then analyzes the ranging event data 220. This analysis may be monitored by a laboratory technician (not shown). This analysis can be used to improve operational characteristics of the PON devices and diagnose faults, for example.

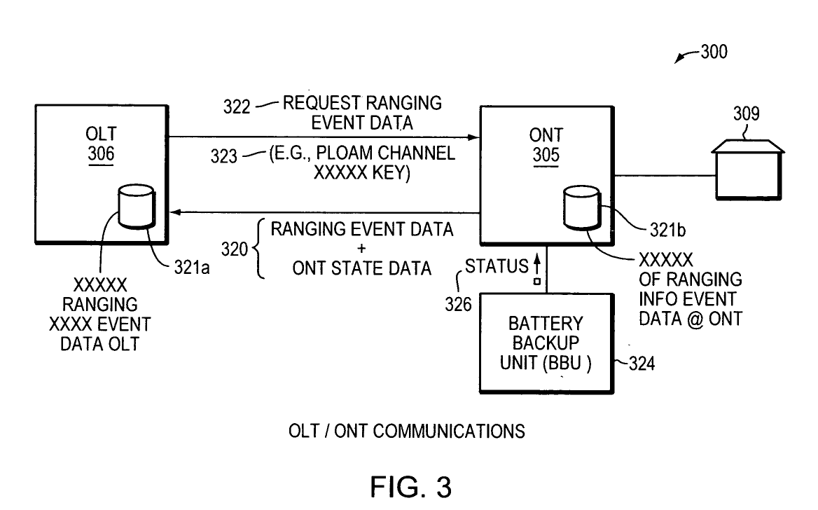

FIG. 3 is a communications diagram 300 demonstrating interaction between an Optical Line Terminal (OLT) 306, Optical Network Terminal (ONT) 308, and Battery Backup Unit (BBU) 324. A Battery Backup Unit (BBU) 324 may be coupled to an ONT 308. The BBU 324 provides actual DC power when the BBU 324 detects the ONT 308 has had a loss of primary power. The BBU 324 also provides status messages 326 periodically or upon detecting, for example, a failure or low-charge. An OLT 306 sends a request for ranging event data 322 to the ONT 308. This request may be done through, for example, a PLOAM channel 323. The ONT 308 can store its ranging event data and its ONT state information data locally 321b. The ONT 308 also stores the status messages 326 provided by the BBU 324. Once the ONT 308 receives the request 322 from the OLT 306, the ONT 308 sends the ranging event data, its state information data 320, and BBU 324 status messages 326 back to the OLT 306. The OLT 306 can then locally store 321a the ONT ranging event data 320 and its OLT state information.

The OLT 306, when requesting ranging event data 322, may request a security key, such as a churnkey that changes over time, from the ONT 308. The OLT 306 requests a new churnkey from the ONT 308 every 30 to 60 seconds. If the ONT 308 chums a churnkey and responds to the OLT 306 every time a request 322 is sent, then the OLT 306 increments a corresponding counter. This counter is used to determine a length of time the ONT 308 has remained ranged with the OLT 306. If for some reason there is a reset, such as caused by an ONT reboot, the OLT 306 rearranges the ONT 308, causing the counter to be reset and, thus, resetting the length of time since the ONT 308 was most recently ranged.

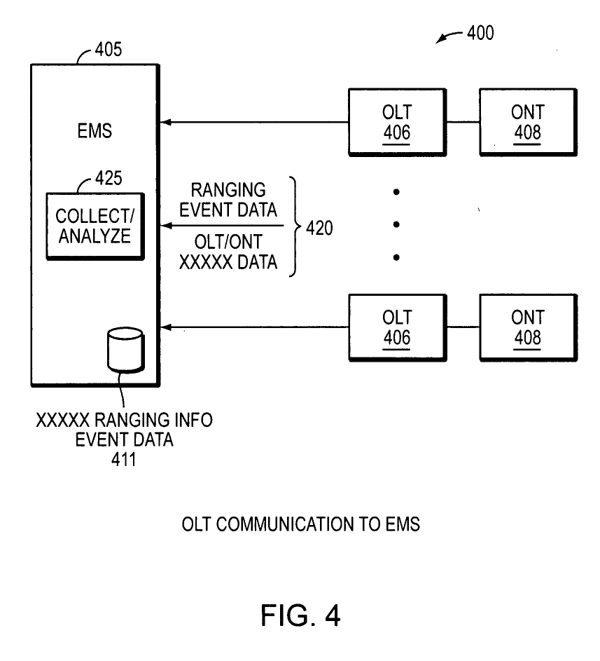

FIG. 4 is a communications diagram demonstrating interaction between several Optical Line Terminals (OLTs) 406 and an Element Management System (EMS) 425. The EMS 425 may be equipped with a correlator 425. An OLT device 406 reports ranging event data and OLT/ONT state data 420 to the EMS 405. The EMS 405 may store the ranging event and state data 420 locally in its database 421. The EMS 405 may then identify a correspondence between the ranging information and state information of the OLT 406, ONT 408 or another PON device (not shown) associated with the operation of the ONT 408 (e.g., a Battery Backup Unit, not depicted) using a correlator 425. The correspondence created by the correlator 425 may also be stored locally in the database 421.

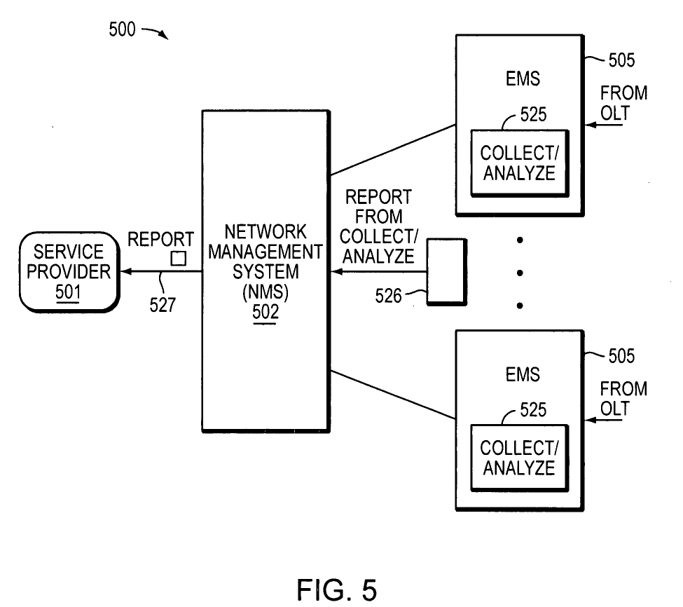

FIG. 5 is a communications diagram in an example field deployed network 500 in which example embodiments may be employed. The diagram illustrates interaction between Element Management Systems (EMSs) 505, a Network Management System (NMS) 502, and a Service Provider 501. The EMS 505, after using a correlator 525 to create a correspondence between ranging information and state information of PON devices 100, may send a correlation report 526 to a NMS 502. The NMS 502, in turn, may send this report to a service provider 501. The correlation report 526 associates a start time of a re-ranging condition with state information of a PON device at the time of re-ranging. The stored information may be converted into a human-readable format for ease of analysis. In reporting the correspondence, the NMS 502 may also assign a priority level for maintenance if it identifies an error in the PON 100.

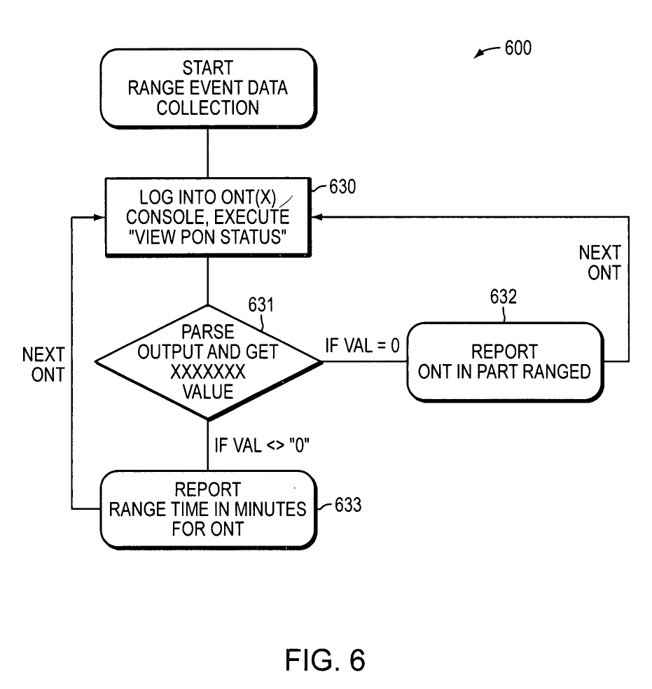

FIG. 6 is a flow diagram illustrating a process 600 of retrieving ranging event data from an ONT. The process 600 begins by logging into an ONT(x) console and executing a command (e.g., “Vex Pon status”) (630). A keyswitch value is given (631). If the value is “0,” then an ONT is not ranged, and this information is reported (632). The process continues by logging into a next ONT (630). If the keyswitch value is greater than or less than “0” (i.e., non-zero), then a report is generated with the ONT range time (633), and the process continues by logging into a next ONT (630). The process 600 continues until all ONT devices have been accessed.

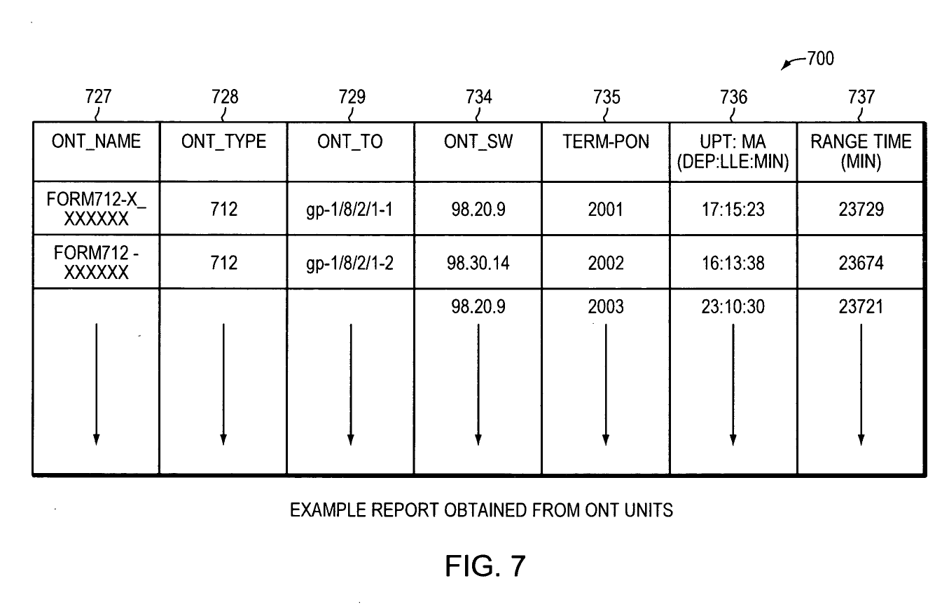

FIG. 7 is a sample report of ranging event data obtained from an Optical Network Terminal (ONT) (not shown). The report includes several columns of example data, including: ONT name 727, type of ONT device 728, ONT identification 729, ONT switch 734, terminal port 735 used, ONT “uptime” 736 (i.e., time duration since most recent ranging), and the ONT range time 737 in minutes corresponding to the uptime 736.

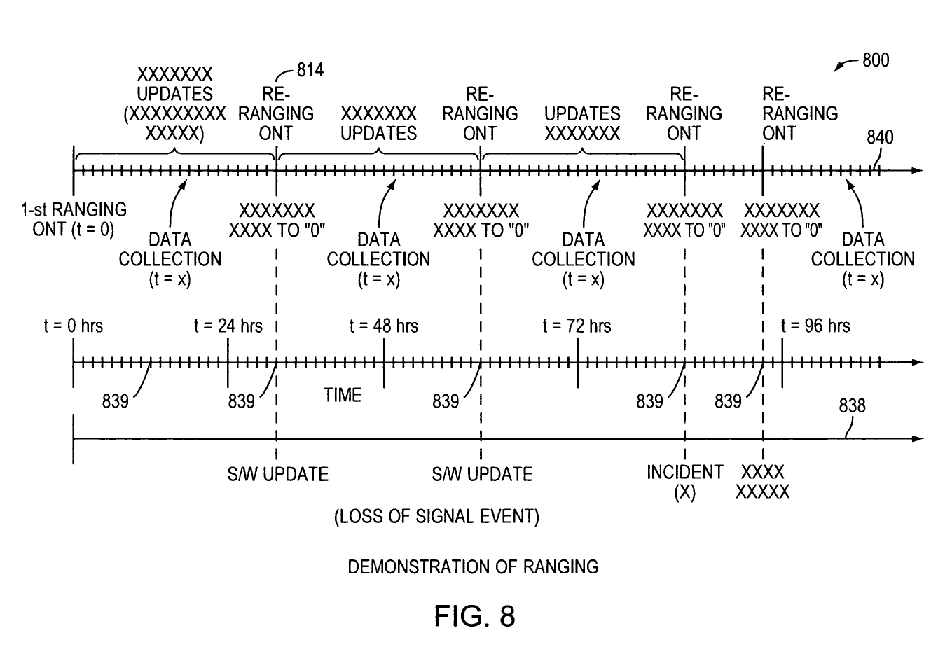

FIG. 8 is a timeline diagram demonstrating ranging event data 800. A time 839 is associated with a loss of signal event 838. At this time 839, an ONT re-ranges, and a churnkey is reset to “0”. If data collection 842 occurs before a loss of signal event 838, the ONT is in a ranged condition, and the churnkey has a value greater then zero, which represents how long the ONT has remained synchronized with the PON. If data collection 842 occurs during a loss of signal event 838, the churnkey is given a value of zero, which represents a re-ranging condition of the ONT. At this time 839, the data collection optionally also retrieves state information of PON devices associated with the operation of the ONT. Some or all retrieved information may be analyzed to diagnose faults and, optionally, provide network management services.

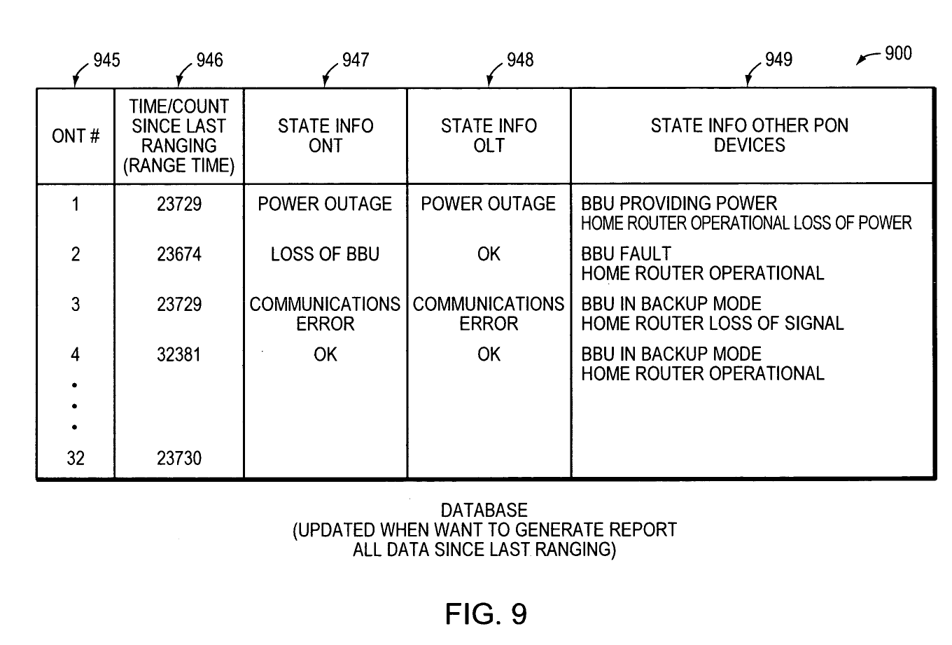

FIG. 9 is a sample report containing ranging event data of each Optical Network Terminal (ONT) and, optionally, state information of the ONT(s), OLT, and other PON devices associated with the ONT(s). The report 900 contains multiple columns, including, for example, columns with: an ONT number 945 used to identify an ONT in the PON, ranging time (or count) 946 of the ONT, state information 947 of the ONT, state information 948 of an OLT in communication with the ONT, and state information 949 of any other PON device associated with the ONT. This report 900 can be used to diagnose faults in the PON by correlating and analyzing the data.

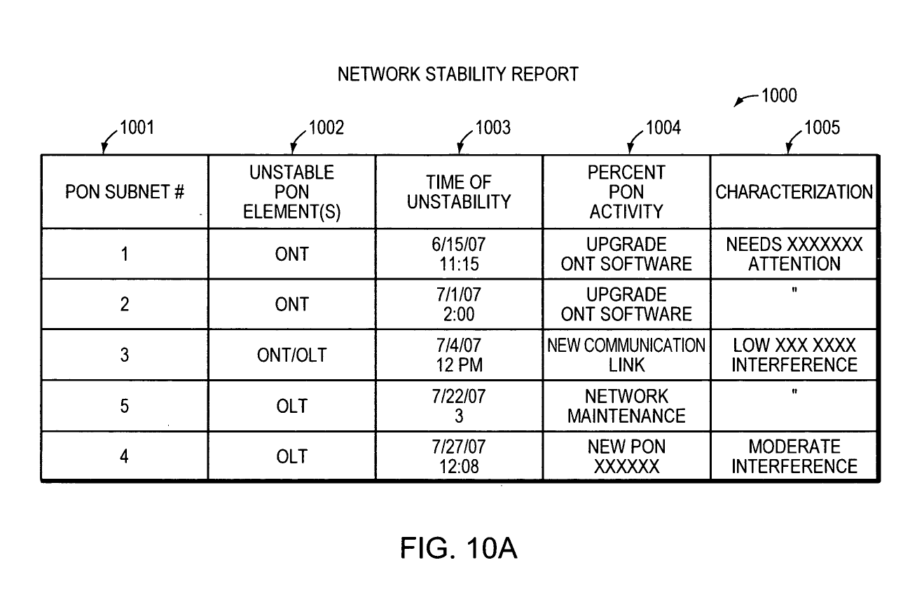

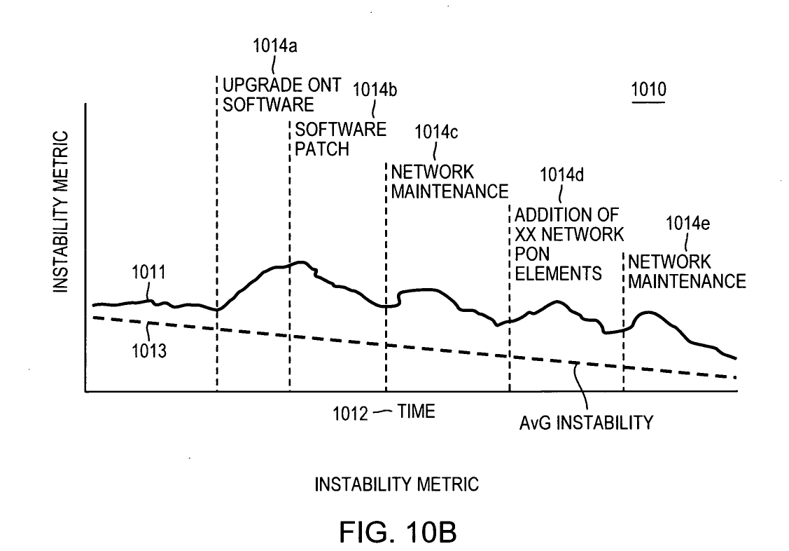

FIG. 10A is a sample network stability report 1000 characterizing a level of attention used to service an unstable PON device. The sample network stability report 1000 contains columns with, for example, information useful for understanding network stability, such as: a PON subnet number 1001 that identifies which network is being analyzed, unstable PON element(s) 1002 (e.g., ONT, OLT), time of instability 1003, recent PON activity 1004 (e.g., software upgrade), and a characterization of the attention level needed 1005. Characterization can be determined as a function of the unstable PON elements(s), type(s) of alarms, or other information understood in the art as being useful to characterize the attention level needed to service the PON.

FIG. 10B is a plot 1010 of an “instability” metric representing average instability of the PON network. The plot 1010 associates an instability of the PON with an event. The instability metric plot 1010 contains a graphical display of a measure of instability solid-line curve 1011 versus a time 1012. An average instability dashed-line curve 1013 is illustrated and demonstrates whether the instability of the PON is on average, decreasing or increasing. Events 1014a-1014e may be indicated on the instability metric plot 1010 to demonstrate potential causes or resolutions of faults in the PON.

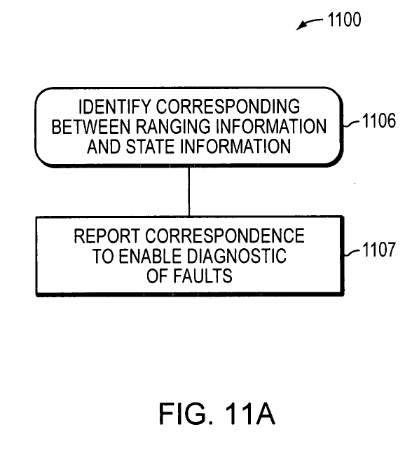

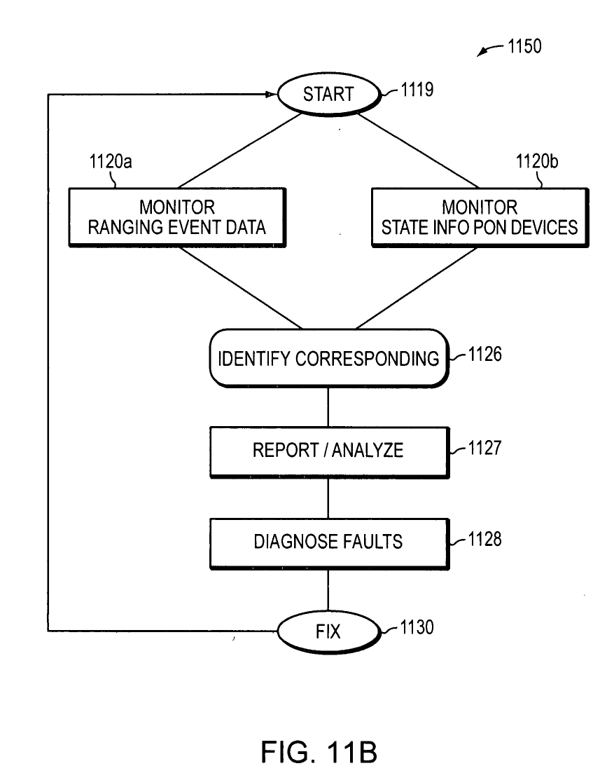

FIG. 11A is a flow diagram of a process 1100 illustrating an example embodiment of the invention. Using ranging event data and state information of PON devices, a correspondence between the ranging event data and state information of the PON devices is identified (1106). Subsequently, a report and/or analysis of the correspondence is created (1107).

FIG. 11B is a flow diagram of a process 1150 illustrating a further example embodiment of the invention. The process 1150 begins (1119) and monitors (1120a, 1120b) ranging event data and state information of PON devices. At any point of data collection a correspondence between ranging event data and state information of PON devices is identified (1126). Subsequently, a report and/or analysis of the correspondence is created (1127). This report and/or analysis is used to diagnose faults (1128) if any are found. If it is determined that any faults are found, the faults may be resolved or fixed (1130). The process 1100 thereafter may begin (1119) again.

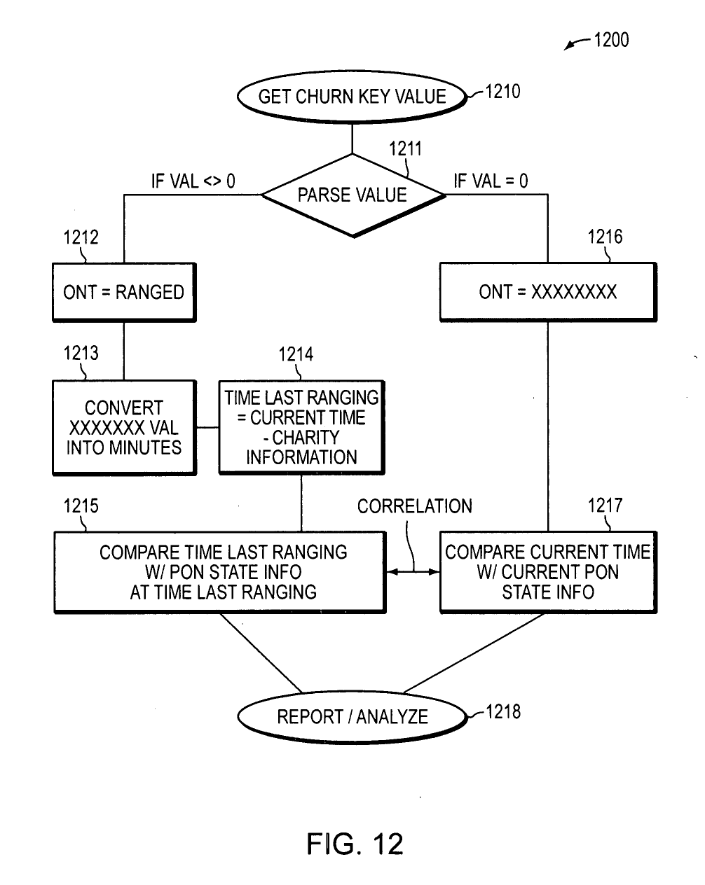

FIG. 12 is a flow diagram illustrating an example process 1200 of correlating ranging event data with state information of devices in the PON. The process 1200 may begin by retrieving a churnkey (or other variable from which time or elapsed time can be determined) value (1210). The value is parsed (1211) to determine whether it is equal to zero or greater/less than zero. If the value is greater/less than zero, the ONT is determined to be ranged (1212). The churnkey value may then be converted into minutes (1213), and the time of last ranging may be calculated (1214) by taking the current time and subtracting the churnkey value. The ranging time is correlated with PON state information (1215), and this information may be reported and analyzed (1218). If the churnkey value is equal to zero, the ONT is re-ranging (1216), the PON state information is correlated with the current time (1217), and the results of the correlation are reported and analyzed (1218).

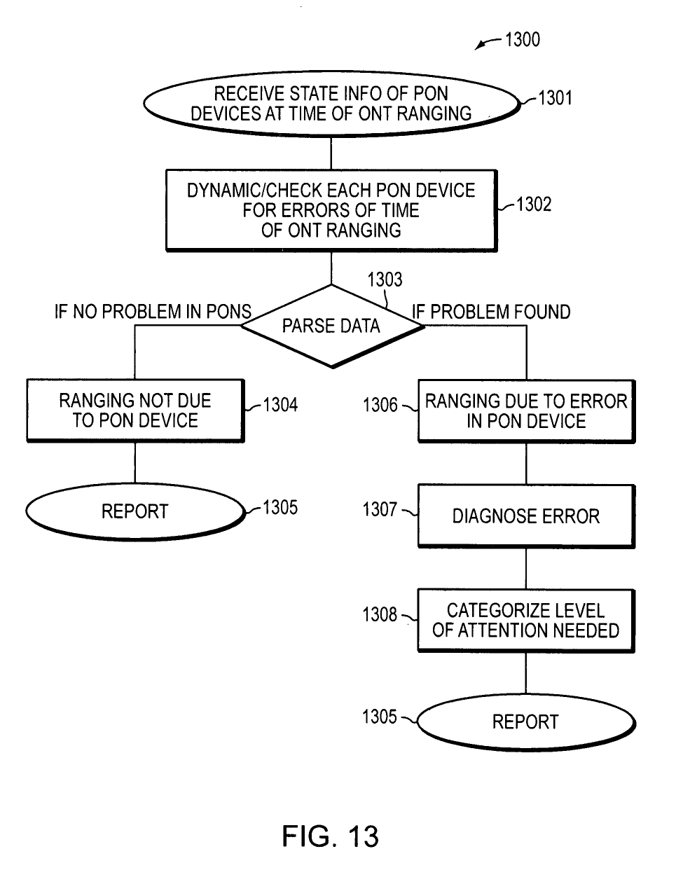

FIG. 13 is a flow diagram illustrating an example process 1300 of analyzing and categorizing correlated data. The process 1300 begins by receiving state information of PON devices at a time of ONT ranging (1301). Each PON device is diagnosed for errors at the time of ONT ranging (1302). The data is parsed (1303) and, if there are no problems found in any PON device, a report is given that the error(s) are not caused by a PON device (1304, 1305). If a problem is found, the error is likely caused by an error in a PON device (1306), and the error may be diagnosed (1307). A report categorizing the level of attention may be given (1305, 1308).

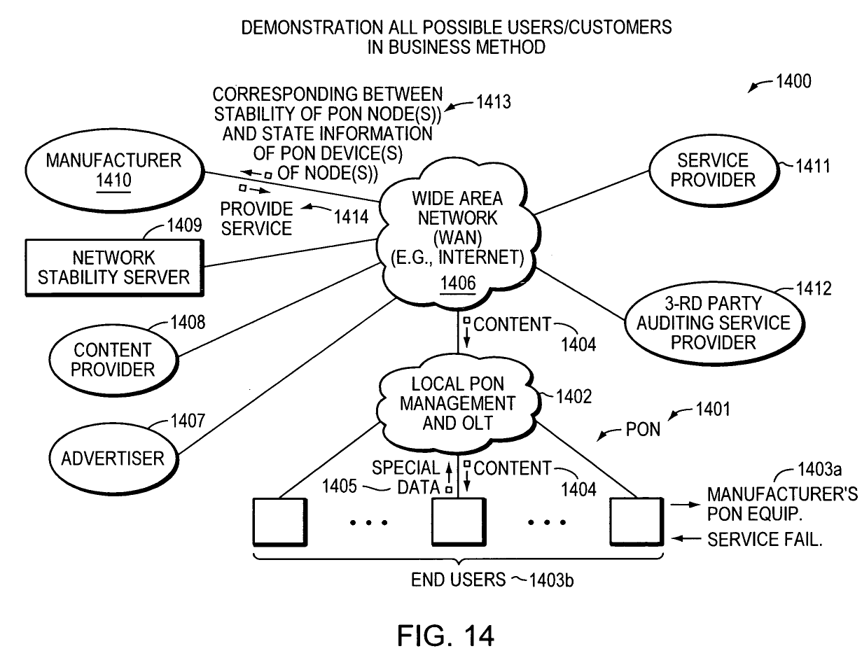

FIG. 14 is a network diagram 1400 illustrating typical parties and equipment that may be associated with network stability maintenance of a PON. The diagram 1400 includes a manufacturer 1410, network stability server 1409, content provider 1408, advertiser 1407, Wide Area network (WAN) 1406, local PON management and OLT 1402, PON 1401, manufacturer's PON equipment 1403a, end-users 1403b, third-party auditing service provider 1412, and service provider 1411.

In the example network diagram 1400 a manufacturer 1410 provides service 1414 through a WAN 1406. The manufacturer 1410 is able to access reports 1413 regarding correspondence between stability of PON node(s) and state information of PON device(s) or node(s) through the WAN 1406. The local PON management and OLT 1401 receives content 1404, which is distributed to manufacturer's PON equipment 1403a in the PON 1401. The end-users 1403b ultimately receive the content 1404 via display or otherwise via the manufacturer's equipment 1403a. Synchronization (Synch) data 1405 is sent back to the WAN 1406 by the manufacturer's PON equipment 1403a.

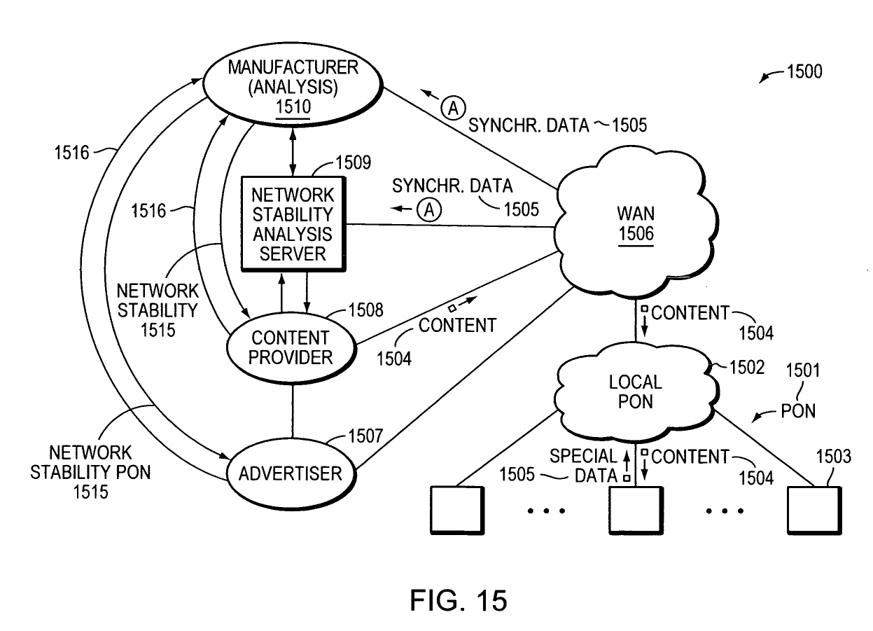

FIG. 15 is a network diagram 1500 illustrating interaction of a manufacturer 1510, content provider 1508, and advertiser 1507 in a context of a WAN 1506, PON 1501, and network stability server 1509. A PON 1502, or device therein, sends synchronization (synch) data 1505 through the WAN 1506 to the manufacturer 1510, a network stability analysis server 1509, or both. The manufacturer 1510 may send network stability information 1515 to a content provider 1508 or an advertiser 1507 in exchange for a fee 1516. The content provider 1508 may also obtain the network stability information 1515 from the network stability analysis server 1509. The content provider 1508 may also provide content 1504 through the use of content servers (not shown) to end-users 1503.

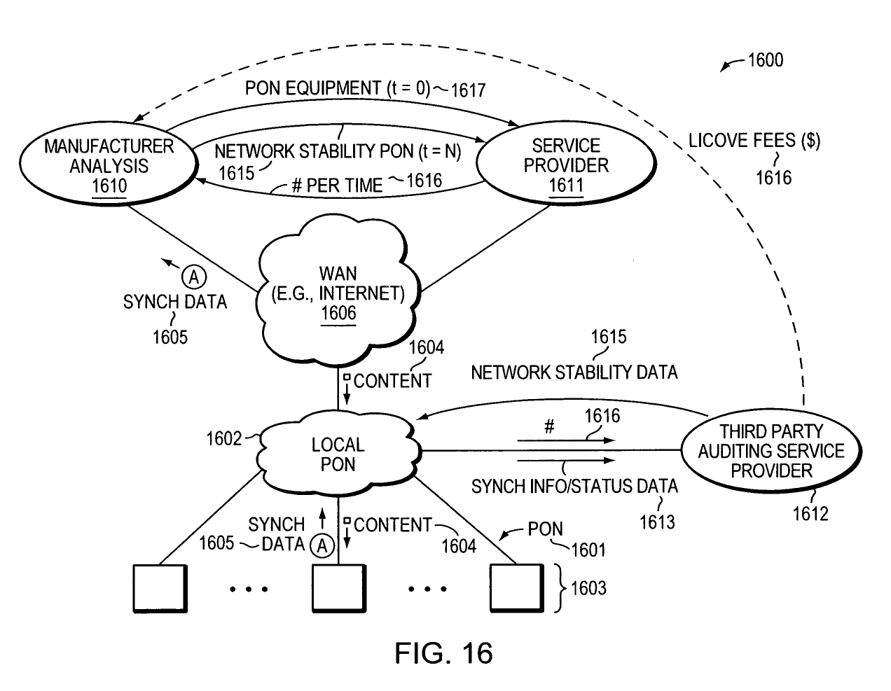

FIG. 16 is a network diagram 1600 illustrating interaction of a manufacturer 1610, service provider 1611, and third-party auditing service provider 1612 in the context of a WAN 1606 and PON 1601. A manufacturer 160 receives synchronization data 1605 via the WAN 1606 from a PON 1601. In an example scenario, the manufacturer 1610, initially, proved PON equipment 1617 to a service provider 1611. The manufacturer 1610 is then able to provide network stability data 1615 to the service provider 1611 for a per instance fee 1616, for example. Similarly, a third-party auditing service provider 1612 may provide similar services through the WAN 1606 for a licensing fee 1616 given to the manufacturer 1610. In commerce, the third-party auditing service provider 1612 receives synchronization data 1605 from the PON 1601 via the WAN 1606 and provides network stability data 1615 for a fee 1616.

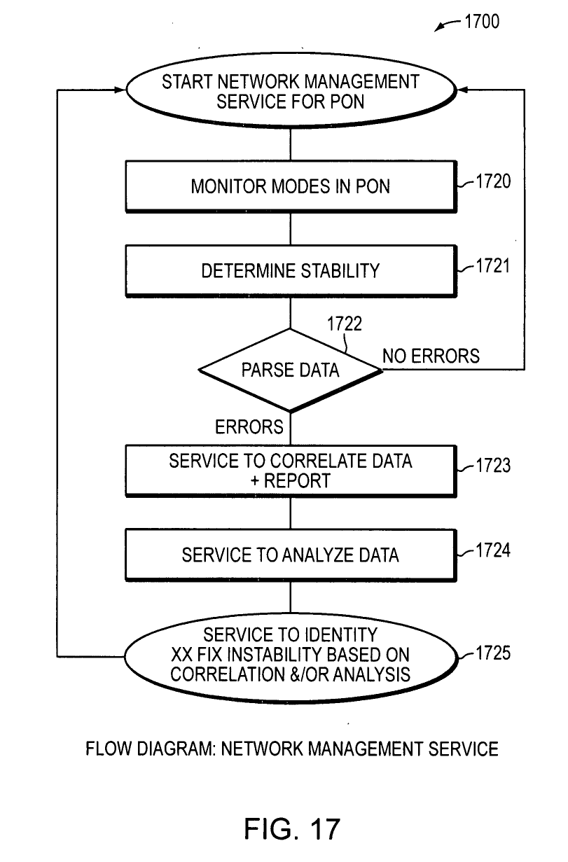

FIG. 17 is a flow diagram illustrating an example of the network management service 1700 provided with the network of FIG. 16 or 17. The service begins by monitoring nodes in the PON (1720). The service 1700 determines the stability (1721) of the PON devices. If there are no errors, the service 1700 continues monitoring nodes (1720). If an error is found, a service to correlate data and report data is provided (1723). The network management service also provides an additional service to analyze the data (1724) and identify or fix any instability based on the correlation (1725). The service 1700 continues monitoring nodes in the PON (1720).

While this invention has been particularly shown and described with references to example embodiments thereof, it will be understood by those skilled in the art that various changes in form and details may be made therein without departing from the scope of the invention encompassed by the appended claims.

For example, any of the flow diagrams described herein may be modified or arranged in any manner to support operation in various network configurations. The flow diagrams may include more or fewer blocks, combined or separated blocks, alternative flow arrangements, or the like. The flow diagrams may also be implemented in the form of hardware, firmware, or software. If implemented in software, the software may be written in any suitable code in accordance with the example embodiments herein or other embodiments. The software may be stored in any form of computer readable medium and loaded and executed by a general purpose or application specific processor suitable to perform the example embodiments described herein or other embodiments.

What is claimed is:

1. A method of enabling diagnosing of faults in a passive optical network (PON), comprising:
identifying a correspondence between ranging information representative of a length of time since a ranging of an optical network terminal (ONT) occurred and state information of the ONT or another PON device associated with operation of the ONT; and
reporting the correspondence to enable diagnosing of faults in the PON.

2. A method according to claim 1 wherein the ranging information includes the number of times over a length of time an encryption key, used to support encrypted communications between the ONT and an optical line terminal (OLT) in communication with the ONT, changed.

3. A method according to claim 2 wherein the encryption key is a churning key that changes over time and further including dividing the number of times the churning key changed by a metric to determine the length of time since the ONT was most recently ranged.

4. A method according to claim 1 further including storing the ranging information.

5. A method according to claim 4 wherein storing the ranging information includes storing the ranging information at least one of the following locations: at the ONT, at an optical line terminal (OLT) in communication with the ONT, or at a management element in communication with the OLT or ONT.

6. A method according to claim 1 wherein reporting the correspondence further includes diagnosing the faults as a function of the correspondence between the ranging information and the state information, and wherein the state information is state information of at least one of the following PON devices: the ONT, a Battery Backup Unit (BBU) coupled to the ONT, another ONT in the PON, an optical line terminal (OLT) in communication with the ONT, or a combination of the OLT and the ONT.

7. A method according to claim 1 wherein identifying the correspondence, and reporting the correspondence occurs in an environment selected from a group consisting of: a laboratory environment and a field operations environment.

8. A method according to claim 1 wherein identifying a correspondence between the ranging information and the state information includes storing the ranging information and the state information in a database and associating a start time of the ranging with a state in the state information.

9. A method according to claim 8 wherein storing the ranging and state information in the database includes converting the ranging information, the state information, and the correspondence to a human-readable format.

10. A method according to claim 1 wherein reporting the correspondence includes reporting the correspondence at least at one of the following locations: locally at the ONT, remotely at an optical line terminal (OLT) in communication with the ONT, or remotely at a management element.

11. A method according to claim 1 wherein reporting the correspondence includes storing the correspondence in a file at a server in communication with the ONT or an optical line terminal (OLT) in communication with the ONT.

12. A method according to claim 1 wherein the ranging information includes ranging information in traffic on a Physical Layer Operations, Administration, and Maintenance (PLOAM) channel, an Operations Management and Control Interface (OMCI) channel, or an in-band traffic channel.

13. A method according to claim 1 wherein reporting the correspondence includes analyzing the correspondence and categorizing the state information of the PON or ONT as a function of the correspondence.

14. A method as claimed in claim 13 wherein categorizing the state of the PON or ONT includes assigning a priority level for maintenance.

15. A system of diagnosing faults in a passive optical network (PON), comprising:
a correlating module to identify a correspondence between the ranging information representative of a length of time since a ranging of an optical network terminal (ONT) occurred and state information of the ONT or another PON device associated with operation of the ONT; and
a reporting module to report the correspondence to enable diagnosing of faults in the PON.

16. A system according to claim 15 diagnosing faults in a passive optical network (PON), comprising:
a monitoring module to examine ranging information of an ONT.

17. A system according to claim 16 wherein the monitoring module includes a logging module to store the ranging and state information in a manner associating a start time of the ranging with a state in the state information.

18. A system according to claim 16 wherein the monitoring module further includes a counting module enabling identification of a number of times over a length of time an encryption key, used to support encrypted communications between the ONT and an optical line terminal (OLT) in communication with the ONT, changed.

19. A system according to claim 18 wherein the encryption key is a churning key, and wherein the counting module further includes a calculation module to divide the number of times the churning key changed by a metric to determine the length of time since the ONT was most recently ranged.

20. A system according to claim 15 further including a logging module to store the ranging information.

21. A system according to claim 20 wherein the logging module is located at least one of the following locations: at the ONT, an optical line terminal (OLT) in communication with the ONT, or a management element in communication with the OLT or ONT.

22. A system according to claim 15 wherein the reporting module further includes a diagnosing module to diagnose faults in the PON as a function of the correspondence between the ranging information and the state information, and wherein the state information is from at least one of the following PON devices: the ONT, a Battery Backup Unit (BBU), another ONT, an optical line terminal (OLT) in communication with the ONT, or a combination of the OLT and the ONT.

23. A system according to claim 15 wherein the correlating module, and reporting module are configured for operation in an environment selected from a group consisting of: a laboratory environment and a field operations environment.

24. A system according to claim 23 wherein the logging module includes a converting module to convert the ranging and state information into a human-readable format.

25. A system according to claim 15 wherein the reporting module is further configured to report the correspondence to at least one of the following PON elements: the ONT, an optical line terminal (OLT) in communication with the ONT, or a management element associated with the ONT.

26. A system according to claim 15 wherein the reporting module further includes a logging module to store the correspondence in a file at a server in communication with the ONT or an optical line terminal (OLT) in communication with the ONT.

27. A system according to claim 15 wherein the ranging information includes ranging information in traffic on a Physical Layer Operations, Administration, and Maintenance (PLOAM) channel, an Operations Management and Control Interface (OMCI) channel, or an in-band traffic channel.

28. A system as claimed in claim 15 wherein the reporting module further includes an analysis module to categorize the correspondence and the state information of the PON or the ONT as a function of the correspondence.

29. A system as claimed in claim 28 wherein the analysis module further includes a designating module to assign a priority level for maintenance.

30. A method of providing a network management service for a Passive Optical Network, comprising:
determining stability of at least a first node in a passive optical network (PON) as a function of a length of time the first node has remained synchronized with at least one second node in the PON;
identifying a correspondence between the stability of the first node and state information of the first node, another PON device, or at least the one second node associated with operation of the first node; and
providing a network management service based on the correspondence.

31. A method as claimed in claim 30 wherein providing the network management service includes correcting a network fault and reporting information about the network fault to at least one of the following: a service provider, manufacturer, network stability server, content provider, advertiser, or third-party auditing service provider.

32. A method as claimed in claim 30 wherein providing the network management service further includes collecting at least a fee for the network management service.

33. A method as claimed in claim 32 wherein collecting the fee further includes at least one of the following: collecting the fee on a subscription basis ranging from a one time, weekly, monthly, or annual subscription basis, invoicing the party for the fee, or collecting the fee on a prepayment basis.

34. A method as claimed in claim 30 wherein determining the stability in the PON further includes counting a number of times over a length of time an encryption key, used to support encrypted communications between the first node and at least one second node changed to determine the length of time the first node has remained synchronized with at least the second node in the PON.

35. A method as claimed in claim 34 wherein the encryption key is a churning key and further including dividing the number of times the churning key changed since a most recent ranging by a metric corresponding to the length of time.
